(19) United States
(12) Patent Application Publication
(10) Pub. No.: US 2020/0221742 A1
(43) Pub. Date: Jul. 16, 2020

(54) FOOD FAT/OIL MIXTURE AND METHOD FOR MANUFACTURING THE SAME

(71) Applicant: MIZKAN HOLDINGS CO., LTD., Aichi (JP)

(72) Inventors: Minoru Takeuchi, Aichi (JP); Daisuke Nishioka, Aichi (JP)

(73) Assignee: MIZKAN HOLDINGS CO., LTD., Aichi (JP)

(21) Appl. No.: 16/829,325

(22) Filed: Mar. 25, 2020

Related U.S. Application Data
(63) Continuation of application No. PCT/JP2019/006425, filed on Feb. 21, 2019.

(30) Foreign Application Priority Data
Feb. 22, 2018 (JP) 2018-029962

(51) Int. Cl. A23L 19/00; A23D 9/02; A23P 10/20

(52) U.S. Cl. CPC A23L 19/01; A23L 27/10; A23P 10/20; A23D 9/02

(57) ABSTRACT

A food mixture may include an oil/fat composition that comprises fine plant particles and a plant oil or fat, and a plant-derived dried food that is embedded in the oil/fat composition. The fine plant particles may have as average particle diameter of 0.3 to 30 μm , the plant oil/fat may be a fluid at 20° C., and the oil/fat composition may contain the fine plant particles in an amount of 10 to 80 mass %.

### TECHNICAL FIELD

One or more embodiments of the present invention relate to a food oil/fat mixture, a method for manufacturing the mixture, a method for maintaining texture and flavor, and a method for improving palatability.

### BACKGROUND

Examples of dried foods include dried products of a vegetable, a bean, a root vegetable, a fruit or a seed, and a cereal food of a grain.

Specific types of dried food are as follows: dried vegetables including a dried onion and a dried Chinese cabbage; dried beans including a kidney bean chip and a soybean chip; dried root vegetables including a beet chip and a carrot chip; dried fruits including a raisin, a dried fig, and a dried berry; dried seeds including a dried nut such as an almond, a walnut, or a pecan; cereals of grains including a processed product of corn, oat, wheat, barley, and rice crushed into thin pieces (flakes), a processed product of puffs (swollen), and a processed product of grains which are made into sheets and then crushed. Further examples of the dried foods include Muesli and Granola, which are prepared by mixing and/or seasoning.

These dried foods are mixed to be daily eaten as “cereals for meals”.

Mostly, these are eaten with dairy products such as milk and yoghurt topped thereover, and may also be eaten with strawberry sauce, blueberry sauce, or the like topped thereover as a flavor.

However, since the dried foods have remarkably high moisture absorbability, they readily become wetted by absorbing moisture from milk or yoghurt, thereby losing the original crunchy or crispy texture of the dried foods immediately while eating, its flavor being diffused into the water. As a result, the dried foods assume an unfavorably tacky texture and a weak flavor, with remarkably poor palatability.

Although the dried foods are distributed in containers or bags having low moisture permeability, after the containers or bags are unsealed, the dried foods unfavorably absorb moisture in the air, and they lose the original crunchy and/or crispy texture of the dried foods, with a weaker flavor.

From another perspective, the dried foods, to be eaten as such, give a dry and/or crumbling texture because they absorb water from saliva in the oral cavity; therefore, they can stick to teeth and have difficulty in passing through the throat, and are remarkably poor in eatability. Thus, as described above, they are often eaten with dairy products topped thereover such as milk and yoghurt. However, in order to do so, it is necessary to prepare other foodstuffs such as milk or yoghurt, and a bowl in which the foodstuffs and the dried foods are mixed; thus, preventing immediate eatability.

Granola is a product by baking a mixture of processed grains with coconut, nut and the like with a syrup (molasses), such as a sugar, a honey, or a maple, and a vegetable oil in an oven. In the manufacturing process, the mixture may be agitated several times during the baking in the oven, the mixture may be crushed into an appropriately agglomerated shape after the completion of baking, or the mixture may be molded or solidified before or after baking to facilitate immediate eatability so that it can be eaten as it is in the form of a bar. However, since it is necessary for the manufacture of granola to bake in an oven at high temperature, nutrients may be lost due to thermal decomposition or the like though the granola contains a large amount of healthful plant-derived raw material. Further, the dried foods such as the processed grains, coconut, nut, and the like temporarily assume a gummy property by moisture in molasses or subsequent baking in the presence of moisture by mixing all the materials or baking in an oven while mixing them, and even if the dried foods are dried again by baking in an oven, the texture inherent in the dried food may be impaired.

To solve the above, the following has been proposed.

A technique is disclosed in which dry fruits containing sugar and glycerin and cereals containing sugar are mixed to give a dry food mixture, whereby water is not transferred from the dry fruit to the cereal, and the moisturizing property of the dry fruit and the texture of the cereal can be maintained (PTL 1). A technique is disclosed in which the outer surface of vacuum-freeze-dried fruit is coated or infiltrated with an oil-based food and the outer peripheral surface of vacuum-freeze-dried fruit is coated or infiltrated with a coating of Zein, whereby excellent water resistance and non-hygroscopicity are exhibited even when the fruit is contacted with moisture or moisture, and the original fruit shape, color, and flavor are utilized (PTL 2).

A technique relating to edible films is disclosed for packaging a food such as an instant food, having low moisture permeability and easy water solubility which protect a packaged content from deterioration due to moisture during distribution and storage and can be used for cooking or eating by bringing the food ingredients into water or hot water without unsealing (PTL 3). It is disclosed that, in the step of producing a rice cracker (senbei) by a conventional method, an oil film is formed on the surface of the rice cracker by a method of producing a rice cracker of excellent quality and productivity by adding the dough immediately after drying to a mixed emulsion of water and oil containing 20 to 50% oil for 2 to 8 seconds and subsequently baking at a temperature of 200 to 300° C., to give a rice cracker hard to moisture even if left to stand (PTL 4). It is disclosed that baked potato chips containing 3 to 50 wt % of oil/fat compositions containing 50 wt % or more of diglyceride and 2 wt % or less of monoglycerides are less susceptible to moisture, have a good texture, and have a good flavor (PTL 5). It is disclosed that an oil-immersed food material obtained by bringing a food material such as fish, vegetables or meat to a weight ratio of 1/1 to 20/1 to heat to 60 to 100° C. and dehydrating the food material to a dehydration rate of 10 to 70 wt % of the retained moisture of the food material can sufficiently exhibit a favorable flavor, texture, color tone, and the like of the food material without changing the favorable flavor, texture, color tone, etc. of the food material, and can overcome an unpleasant flavor such as a malodor derived from raw materials (PTL 6).

### PATENT LITERATURE

[PTL 1] JP-A-2017-6005

[PTL 2] JP-A-Hei 6-284875

[PTL 3] JP-A-2011-103788

[PTL 4] JP-A-Hei 7-184549

[PTL 5] JP-A-2002-191314

[PTL 6] JP-A-Hei 10-215762

PTLs 1, 2 and 3, teach that the flavor and texture of dried foods can be maintained by containing sugar and/or glycerin, coating or infiltrating the oil/fat food and further forming a Zein film over the outer peripheral surface of the dried food, or wrapping the dried food with an edible film for food packaging. However, due to the properties derived from the raw materials and shapes of the dried food, the above techniques may not be generally applicable to all of these foods, and some objects are hard to apply the above techniques. Moreover, in contrast to inexpensive raw materials, due to the complicated process, there remains an issue of high costs. PTLs 4 and 5 teach that, in the manufacturing process of rice crackers and potato chips, impregnating oil before baking enables to maintain a pleasant texture and taste without becoming moist. Because of the characteristics derived from the raw materials and shapes of the respective dry foods, there are objects to which the techniques may not be applied in general. Further, the flavor inherent to the food may be altered in some of the dry foods, because baking is performed after impregnating the oil, depending on the type of the dry foods. PTL 6 teaches that food materials such as fish, vegetables and meat can be prepared as an oil-immersed food with a favorable flavor, texture, color, etc. of the food material unchanged, by heating the food material together with oil/fat at a low temperature and dehydrating, but such a food material still lacks a crunchy and crispy feeling specific to the dry food.

### SUMMARY

One or more embodiments of the present invention provide a food/drink containing the dried food, which does not moist various dry foods without requiring costs and complicated labor, and retains a pleasant crunchy and/or crispy texture, flavors and nutrients, and that is excellent in eating readily.

As a result of intensive studies, the present inventors found that, when dried foods derived from plants are embedded in a flowable oil/fat composition which contains a certain amount of fine plant particles having a small particle size, dried foods in the obtained mixture are not moist, and the mixture retains the inherent crunchy and/or crispy texture, flavor, and nutrients of the mixture, to obtain a food/drink composition excellent in eating readily.

One or more embodiments of the present invention provide the following, [1] to [22].

[1] A mixture of a food and an oil/fat, comprising: an oil/fat composition comprising fine plant particles and a plant oil/fat; and a plant-derived dried food embedded in the oil/fat composition, wherein
the fine plant particles have an average particle diameter of 0.3 μm or more and 30 μm or less,
the plant oil/fat has fluidity at 20° C., and the weight percentage of the fine plant particles is 10 mass % or more and 80 mass % or less in the oil/fat composition.
[2] The mixture of the food and the oil/fat according to [1], wherein the weight percentage of the dried food is 20 mass % or more and 80 mass % or less in the mixture of the food and the oil/fat.
[3] The mixture of the food and the oil/fat according to [1] or [2], wherein the volume percentage of the dried food is 25 vol % or more and 65 vol % or less in the mixture of the food and the oil/fat.
[4] The mixture of the food and the oil/fat according to any one of [1] to [3], wherein the oil/fat composition comprising the fine plant particles and the plant oil/fat is prepared by wet micronization of dry plant powder with the plant oil/fat.
[5] The mixture of the food and the oil/fat according to [4], wherein the wet micronization is performed using a wet medium stirring mill.
[6] The mixture of the food and the oil/fat according to any one of [1] to [5], wherein the fine plant particles are derived from one or more materials selected from the group consisting of a grain, a potato, a bean, a seed, a vegetable, a mushroom, a spice and a herb.
[7] The mixture of the food and the oil/fat according to any one of [1] to [6], wherein the dried food is derived from one or more materials selected from the group consisting of a grain, a potato, a bean, a seed, a vegetable, a fruit, a mushroom, a spice and a herb.
[8] The mixture of the food and the oil/fat according to any one of [1] to [7], wherein the content of an emulsifier in the mixture of the food and the oil/fat is 1 mass % or less.
[9] The mixture of the food and the oil/fat according to any one of [1] to [8], wherein the water content in the mixture of the food and the oil/fat is 3 mass % or less.
[10] The mixture of the food and the oil/fat according to any one of [1] to [9], wherein the mixture of the food and the oil/fat is not heat-sterilized.
[11] A solidified mixture of a food and an oil/fat, which is prepared by solidifying the mixture of the food and the oil/fat according to [1] to [10] using a sugar solution with a water content of 10 mass % or more and 40 mass % or less.
[12] The solidified mixture of the food and the oil/fat according to [11], wherein the sugar solution is one or more materials selected from the group consisting of a plant-derived juice, sap, a purified product of a plant-derived juice or sap and a concentrated product of a plant-derived juice or sap.
[13] The solidified mixture of the food and the oil/fat according to [12] , wherein the plant-derived juice or sap, a purified product of a plant-derived juice or sap and or a concentrated product of a plant-derived juice or sap is derived from one or more materials selected from the group consisting of a fruit juice, a date, a sugarcane, a maple and a honey.
[14] A method for producing the mixture of the food and the oil/fat according to any one of [1] to [10], comprising mixing the dried food with the oil/fat composition comprising the fine plant particles and the plant oil/fat to embed the dried food in the oil/fat composition.
[15] The method according to [14], further comprising preparing the oil/fat composition through micronization of the fine plant particles and the plant oil/fat using a wet medium stirring mill.
[16] The method for producing the solidified mixture of the food and the oil/fat according to any one of [11] to [13], comprising adding a sugar solution with a water content of 10 mass % or more and 40 mass % or less to the mixture of the food and the oil/fat according to any one of [1] to [10] for solidification.
[17] The method according to [16], wherein the solidification is performed by heat-drying.
[18] A method for retaining the texture and the flavor of a plant-derived dried food, comprising mixing the dried food with an oil/fat composition to embed the dried food in the oil/fat composition, wherein the oil/fat composition comprises fine plant particles with an average particle diameter of 0.3 μm or more and 30 μm or less, and a plant oil/fat having fluidity at 20° C., and the weight percentage of the fine plant particles is 10 mass % or more and 80 mass % or less in the oil/fat composition.
[19] The method according to [18], further comprising preparing the oil/fat composition through micronization of the fine plant particles and the plant oil/fat using a wet medium stirring mill.
[20] A method for improving eatability while retaining the texture and the flavor of a plant-derived dried food, comprising adding a sugar solution with a water content of 10 mass % or more and 40 mass % or less to a mixture of a food and an oil/fat for solidifying the mixture, wherein the mixture is prepared by mixing a dried food with an oil/fat composition to embed the dried food in. the oil/fat composition, wherein the oil/fat composition comprises fine plant particles with an average particle diameter of 0.3 μm or more and 30 μm or less, and a plant oil/fat having fluidity at 20° C., and the weight percentage of the fine plant particles is 10 mass % or more and 80 mass % or less in the oil/fat composition.
[21] The method according to [20], further comprising preparing the oil/fat composition through micronization of the fine plant particles and the plant oil/fat using a wet medium stirring mill.
[22] The method according to [20], wherein the solidification is performed by heat-drying.

One or more embodiments of the present invention provide a mixture of a plant-derived dried food and a plant-derived oil/fat composition having fluidity at 20° C., in which dried foods are embedded in oil/fat composition to prevent the dried food from getting moist, to retain the original crunchy and crispy texture, flavor and nutrients, and to provide excellent immediate eatability.

### DETAILED DESCRIPTION

Hereinafter, a mixture of a food and an oil/fat, a production method thereof, a method for retaining texture and flavor, and a method for improving eatability, of one or more embodiments of the present invention will be described in detail.

One or more embodiments of the present invention relate to a mixture containing a plant-derived dried food and a plant-derived oil/fat composition having fluidity at 20° C., wherein the oil/fat composition contains 10-80 mass % of fine plant particles having an average particle diameter of 0.3-30 μm , and the dried food is embedded in the oil/fat composition.

The term “plant-derived dried food(s)” refers to an ingredient contained in a mixture herein, prepared by embedding the dried food in an oil/fat composition (hereinafter may also be referred to as “the mixture of one or more embodiments of the present invention”), and has crunchy and crispy textures. Specific examples thereof include dried products of a vegetable, a bean, a root vegetable, a fruit and a seed, and a cereal food such as grain. The expression “dry (or dried)” state as used herein means a state in which the water content is 20 mass % or less as measured by a heat-drying method, and refers to a state in which water activity after drying is lowered to a level that enables storage at room temperature (20° C.) and allows no microbial growth regardless of the drying method.

Plant-derived dried foods of one or more embodiments may be those derived from one or more materials selected from the group consisting of a grain, a potato, a bean, a seed, a vegetable, a fruit, a mushroom, a spice, and an herb.

One or more examples of the grain include amaranth, foxtail millet, oat, barley, proso millet, wheat, rice, buckwheat, corn, pearl barley, Japanese barnyard millet, sorghum, rye, triticale, fonio, quinoa, giant corn, sugar cane and the like. Use of these grains provide crunchy and crispy textures. Each of the above foodstuffs can be used regardless of edible or non-edible parts.

One or more examples of the potato include Jerusalem artichoke, konjac potato, sweet potato, Satoimo (Colocasia esculenta), Mizuimo (Calla palustris), Yatsugashira (Colocasia esculenta Schott), potato (Solanum tubersum), Yamanoimo (Dioscorea japonica), Ichoimo (kind of Chinese yams (Dioscorea opposita Thunb.)), Nagaimo (kind of Chinese yam (Dioscorea polystachya)), Yamatoimo (kind of Chinese yam (Dioscorea japonica Thunb.)), Jinenjo (or Yamanoimo (Dioscorea japonica)), purple yam, cassava, yacon, taro, Polynesian arrowroot, purple sweet lord, yam and the like. Use of these potatoes may provide crunchy and crispy textures and sweetness. Each of the above foodstuffs can be used regardless of edible or non-edible parts.

One or more examples of the bean include adzuki bean, kidney bean, pea, cowpea, broad bean, soybean, ricebean, chickpea, runner bean, lima bean, mung bean, lentil, green pea, winged bean, hyacinth bean and the like. Use of these beans may provide crunchy and crispy textures, unique bean flavors, and specific color tones. Each of the above foodstuffs can be used regardless of edible or non-edible parts.

One or more examples of the seed include almond, cannabis, perilla, cashew nut, Japanese torreya, ginkgo, chestnut, walnut, poppy, coconut, sesame, chinquapin, Japanese horse chestnut, lotus, water chestnut, pistachio, sunflower, brazil nut, hazelnut, pecan, macadamia nut, pine, groundnut and the like. Use of these seeds may provide a crunchy and crispy texture, unique chewiness and unique fragrant flavor. Each of the above foodstuffs can be used regardless of edible or non-edible parts.

One or more examples of the vegetable include artichoke, Asatsuki (Allium schoenoprasum var. foliosum), Ashitaba (Angelica keiskei), asparagus, udo, Yamaudo (udo (Aralia cordata Thunb.)), green soybean, pea sprout, podded pea, snap pea, Osaka shirona (Brassica campestris var. amplexicaulis), saltwort, okra, turnip, pumpkin, mustard greens, cauliflower, dried gourd shaving (produced from bottle gourd), chrysanthemum, cabbage, green ball (cabbage), red cabbage, cucumber, victory onion, potherb mustard, Chinese celery, watercress, threeleaf arrowhead, kale, German turnip or turnip cabbage, ostrich fern, burdock, turnip green, sichuan vegetable, shantung vegetables, green pepper, perilla, yardlong bean, crown daisy, water shield, Hashouga (Zingiber officinale), ginger, oriental pickling melon, taro stem, turnip, zucchini, water dropwort, celery, Japanese royal fern, tatsoi spinach mustard, white radish sprouts, Ha-daikon (Raphanus sativus var. longipinnatus), Daikon, Tsumamina (Brassica campestris var. peruviridis), Taisai (Brassica rapa var. chinensis), Takana (leaf mustard), bamboo shoot, onion, red onion, Taranome (shoots of Aralia elata), chicory, qing-geng-cai, field horsetail, New Zealand spinach, Indian spinach, leopard plant, chili pepper, winter melon, sweet corn, young corn, tomato, red-leaved chicory, Tonburi (heat-processed product of the mature fruits of Bassia scoparia), semi-heading Chinese cabbage, eggplant, Beinasu (eggplant), shepherd's purse, tarnip rape, bitter cucumber, oriental garlic, spring star, yellow Chinese leek, Ha-ninjin (carrot), carrot, kyoto red carrot, mini carrot, garlic, garlic stem, green onion, Nozawana (Brassica rapa var. hakabura), Nobiru (Allium macrostemon), Chinese cabbage, Pak-choi, radish, chayote, beet, sweet pepper, Hinona (Brassica campestris var. akana), Hiroshimana (Brassica campestris var. amplexicaulis), fuki, Japanese butterbur, Swiss chard, broccoli, loofah, spinach, horseradish, manchurian wild rice, Mizukakena (Brassica campestris (rapifera group)), Japanese honeywort, myoma, propagule, Brussels sprout, smart weed sprout, bean sprout, Jew's mallow, pokeweed, lily bulb, water-convolvulus, Yomena (Aster yomena), mugwort, groundnut, Japanese shallot, shallot, leek, rhubarb, lettuce, butter lettuce, lettuce, lotus root, arugula, tree onion, Japanese horseradish, western bracken fern, Kuzu (Pueraria lobata), tea plant (brown), paprika and the like. Use of these vegetables may provide crunchy and crispy textures, and strong unique aromas, tastes, and color tones. Each of the above foodstuffs can be used regardless of edible or non-edible parts.

One or more examples of the fruit include akebia, acerola, atemoya, avocado, apricot, strawberry, fig, citrus iyo, Japanese apricot, citrus unshiu, olive, orange, persimmon, citrus kabosu, Chinese quince, kiwifruit, Kiwano (Cucumis metuliferus), kumquat, guava, gooseberry, thorny olive, grapefruit, coconut, starfruit, sweet cherry, pomegranate, citrus sulcata, shiikuwasha, watermelon, citrus sudachi, prum, prune, sour orange, tangor, tangelo, cherimoya custard apple, durian, citrus hassaku, passionfruit, banana, papaya, pitaya, Hyuganatsu (Citrus tamurana), loquat, grape, blueberry, pummelo, white sapote, ponkan mandarin, oriental melon, common quince, mango, mangosteen, melon, peach, nectarine, red bayberry, citrus yuzu, lychee, lime, raspberry, goldenberry, date (date fruits), longan, apple, lemon and the like. Use of these fruits may provide crunchy and crispy textures, and dried fruits' unique chewiness and unique strong aromas, tastes and color tones. Each of the above foodstuffs can be used regardless of edible or non-edible parts.

One or more examples of the mushroom include winter mushroom, Jew's ear, abalone mushroom, Shiitake mushroom, Hatakeshimeji (Lyophyllum decastes), beech mushroom, Honshimeji (Lyophyllum shimeji), golden oyster mushroom, butterscotch mushroom, Numerisugitake (Pholiota adiposa), oyster mushroom, king oyster mushroom, Maitake mushroom, mushroom, Matsutake mushroom, black poplar mushroom and the like. Use of these mushrooms may provide crunchy and crispy textures, unique aroma, and umami. Each of the above foodstuffs can be used regardless of edible or non-edible parts.

One or more examples of the spice and herb include allspice, clove, pepper, Japanese pepper, cinnamon, sage, thyme, chili pepper, nutmeg, basil, parsley, oregano, rosemary, peppermint, savory, lemongrass, dill, wasabi leaf, Japanese pepper leaf, stevia and the like. Use of these spices and herbs may provide crunchy and crispy textures, and unique strong flavors. Each of the above foodstuffs can be used regardless of edible or non-edible parts.

A drying method for the above dried foods are not particularly limited as long as drying can be performed, and examples thereof include sun drying, shade drying, freeze drying, air drying (hot air drying, fluidized bed drying method, spray drying, drum drying, low temperature drying, etc.), pressure drying, vacuum drying, microwave drying, oil heat-drying, etc. Air drying (particularly drying at normal temperature or quick hot air drying in view of minimizing changes in quality) or freeze drying may be employed because these methods allow easy adjustment of water content regardless of materials and are convenient for industrial mass processing.

Among others, grains are processed into cereals, specifically those prepared by crushing grains into thin pieces (flakes), by puffing (swelling) grains, or by mixing grains, shaping the mixture into sheets and then crushing the sheets, so as to facilitate eating with light force.

The dried food may be produced by drying foods by the above means or may be produced by pulverizing a dried food. In a pulverized product of one or more embodiments, the particle diameter is 50 μm or more, 75 μm or more, or 100 μm or more, in view of retaining the texture and flavor of the dried food. The upper limit may be 20 mm or less in view of eatability.

In one or more embodiments of the present invention, the plant-derived oil/fat composition is a composition containing oil/fat and fine plant particles having an average particle diameter of 0.3 μm or more and 30 μm or less in an amount of 10 mass % or more and 80 mass % or less. Of these, the oil/fat is not particularly limited as long as it has fluidity at 20° C., and examples thereof include sesame oil, rapeseed oil, soybean oil, palm mid fraction (PMF), cottonseed oil, corn oil, sunflower oil, safflower oil, olive oil, linseed oil, rice oil, camellia oil, perilla oil, grape seed oil, peanut oil, almond oil, avocado oil, salad oil, and canola oil. Among them, olive oil may have a unique flavor that improves the flavor of the dried food mixture of one or more embodiments of the present invention. The fluidity of an oil/fat at 20° C. can be measured by a technique using, e.g., a Bostwick consistometer (viscometer), and the oil/fat may be in forms ranging from paste to liquid.

In one or more embodiments of the present invention, the plant-derived oil/fat composition includes fine plant particles having an average particle diameter of 0.3 μm or more in view of viscosity at which the dried food is sufficiently embedded in the oil/fat composition and the homogeneity of the oil/fat composition. The average particle diameter is 0.5 μm or more, or 1.0 μm or more, in view of doubts regarding the safety of nanomaterials. On the other hand, in one or more embodiments, the upper limit of the average particle diameter is 30 μm or less, 25 μm or less, or 20 μm or less, in view of causing no rough texture derived from the oil/fat composition. Here, the average particle diameter is measured using a laser diffraction particle size distribution analyzer, such as Microtrac MT3300 EXII system manufactured by MicrotracBEL Corp., distilled water as a solvent for measurement, and DMS2 (Data Management System version 2, MicrotracBEL Corp.) as measurement application software, to find the particle size (d50) measured by DMS2.

The weight percentage of the fine plant particles in the oil/fat composition of one or more embodiments is 10 mass % or more, and, in view of viscosity at which the dried food is sufficiently embedded in the oil/fat composition and the homogeneity of the oil/fat composition, may be 15 mass % or more, or 20 mass % or more. On the other hand, the upper limit may be 80 mass % or less, 70 mass % or less, or 60 mass % or less, in view of the fluidity of the dried food for allowing sufficient embedding thereof in the oil/fat composition.

The plant from which the above fine plant particles are derived may be one or more materials selected from the group consisting of a grain, a potato, a bean, a seed, a vegetable, a mushroom, a spice and a herb.

One or more examples of the grain include amaranth, foxtail millet, oat, barley, prose millet, wheat, rice, buckwheat, corn, pearl barley, Japanese barnyard millet, sorghum, rye, triticale, fonio, quinoa, giant corn, sugar cane and the like. Use of these grains may provide strong sweetness and a strong dispersion-stabilizing effect. Each of the above foodstuffs can be used regardless of edible or non-edible parts.

One or more examples of the potato include Jerusalem artichoke, konjac potato, sweet potato, Satoimo (Colocasia esculenta), Mizuimo (Calla palustris), Yatsugashira (Colocasia esculenta Schott), potato (Solanum tuberosum), Yamanoimo (Dioscorea japonica), Ichoimo (kind of Chinese yams (Dioscorea opposita Thunb.)), Nagaimo (kind of Chinese yam (Dioscorea polystachya)), Yamatoimo (kind of Chinese yam (Dioscorea japonica Thunb.)), Jinenjo (or Yamanoimo (Dioscorea japonica)), purple yam, cassava, yacón, taro, Polynesian arrowroot, purple sweet lord, yam and the like. Use of these potatoes may provide strong viscosity. Each of the above foodstuffs can be used regardless of edible or non-edible parts.

One or more examples of the bean include adzuki bean, kidney bean, pea, cowpea, broad bean, soybean, ricebean, chick pea, runner bean, lima bean, mung bean, lentil, green pea, winged bean, hyacinth bean and the like. Use of these beans may provide a strong emulsifying effect. Each of the above foodstuffs can be used regardless of edible or non-edible parts.

One or more examples of the seed include almond, cannabis, perilla, cashew nut, Japanese torreya, ginkgo, chestnut, walnut, poppy, coconut, sesame, chinquapin, Japanese horse chestnut, lotus, water chestnut, pistachio, sunflower, brazil nut, hazelnut, pecan, macadamia nut, pine, groundnut and the like. Use of these seeds may provide strong unique fragrance. Each of the above foodstuffs can be used regardless of edible or non-edible parts.

One or more examples of the vegetable include artichoke, Asatsuki (Allium schoenoprasum var. foliosum), Ashitaba (Angelica keiskei), asparagus, udo, Yamaudo (udo (Aralia cordata Thunb)), green soybean, pea sprout, podded pea, snap pea, Osaka shirona (Brassica campestris var. amplexicaulis), saltwort, okra, turnip, pumpkin, mustard greens, cauliflower, dried gourd shaving (produced from bottle gourd), chrysanthemum, cabbage, green ball (cabbage), red cabbage, cucumber, victory onion, potherb mustard, Chinese celery, watercress, threeleaf arrowhead, kale, German turnip or turnip cabbage, ostrich fern, burdock, turnip green, sichuan vegetable, shantung vegetables, green pepper, perilla, yardlong bean, crown daisy, water shield, Hashouga (Zingiber officinale), ginger, oriental pickling melon, taro stem, turnip, zucchini, water dropwort, celery, Japanese royal fern, tatsoi spinach mustard, white radish sprouts, Ha-daikon (Raphanus sativus var. longipinnatus), Daikon, Tsumamina (Brassica campestris var. peruviridis), Taisai (Brassica rapa var. chinensis), Takana (leaf mustard), bamboo shoot, onion, red onion, Taranome (shoots of Aralia elata), chicory, qing-geng-cai, field horsetail, New Zealand spinach, Indian spinach, leopard plant, chili pepper, winter melon, sweet corn, young corn, tomato, red-leaved chicory, Tonburi (heat-processed product of the mature fruits of Bassia scoparia), semi-heading Chinese cabbage, eggplant, Beinasu (eggplant), shepherd's purse, tarnip rape, bitter cucumber, oriental garlic, spring star, yellow Chinese leek, Ha-ninjin (carrot), carrot, kyoto red carrot, mini carrot, garlic, garlic stem, green onion, Nozawana (Brassica rapa var. hakabura), Nobiru (Allium macrostemon), Chinese cabbage, Pak-choi, radish, chayote, beet, sweet pepper, Hinona (Brassica campestris var. akana), Hiroshimana (Brassica campestris var. amplexicaulis), fuki, Japanese butterbur, Swiss chard, broccoli, loofah, spinach, horseradish, manchurian wild rice, Mizukakena (Brassica campestris (rapifera group)), Japanese honeywort, myoga, propagule, Brussels sprout, smart weed sprout, bean sprout, Jew's mallow, pokeweed, lily bulb, water-convolvulus, Yomena (Aster yomena), mugwort, groundnut, Japanese shallot, shallot, leek, rhubarb, lettuce, butter lettuce, lettuce, lotus root, arugula, tree onion, Japanese horseradish, western bracken fern, Kuzu (Pueraria lobata), tea plant (brown), paprika and the like. Use of these vegetables may provide strong unique aromas, tastes, and color tones. Each of the above foodstuffs can be used regardless of edible or non-edible parts.

One or more examples of the mushroom include winter mushroom, Jew's ear, abalone mushroom, shiitake mushroom, Hatakeshimeji (Lyophyllum decastes), beech mushroom, Honshimeji (Lyophyllum shimeji), golden oyster mushroom, butterscotch mushroom, Numerisugitake (Pholiota adiposa), oyster mushroom, king oyster mushroom, Maitake mushroom, mushroom, Matsutake mushroom, black poplar mushroom and the like. Use of these mushrooms may provide strong unique aroma and umami. Each of the above foodstuffs can be used regardless of edible or non-edible parts.

One or more examples of the spice and herb include allspice, clove, pepper, Japanese pepper, cinnamon, sage, thyme, chili pepper, nutmeg, basil, parsley, oregano, rosemary, peppermint, savory, lemongrass, dill, wasabi leaf, Japanese pepper leaf, stevia and the like. Use of these spices and herbs may provide unique strong flavors. Each of the above foodstuffs can be used regardless of edible or non-edible parts.

In one or more embodiments of the present invention, the above plant-derived oil/fat composition contains fine plant particles and has fluidity at 20° C., wherein the plant-derived oil/fat contains fine plant particles. The plant-derived oil/fat composition of one or more embodiments is produced by wet micronization of the above plant together with plant-derived oil/fat having fluidity at 20° C. The processing method may not be limited to one or more embodiments of the present invention as long as it is capable of obtaining plant homogenates through processing with high shear force for a short time. For example, medium stirring mills such as a bead mill, a ball mill (rolling type, vibration type, planetary type mill, etc.), a roll mill, a colloid mill, a starburst, a high-pressure homogenizer, etc., can be used. In view of processing efficiency, a colloid mill, a high-pressure homogenizer, a roll mill, or a bead mill that is a medium stirring mill can be more suitably used. In particular, a medium stirring mill is used in view of the homogeneity of the components of the oil/fat composition after preparation. In addition, each method may employ a technique: (a) for processing via circulation of plant homogenates as a raw material or (b) a one-pass technique in which plant homogenates are caused to pass through only once. In view of work efficiency, processing with the one-pass technique is used. Reasons for selecting the one-pass technique include: some dry micronization processes take effort and cost for obtaining a desired particle diameter through pulverization; while, handling of powders after pulverization is difficult because of powder swirling (powders are excessively fine so as to fly around in the air) and high hygroscopicity. On the other hand, because plants contain a large amount of dietary fibers with high water absorption, wet micronization in water may be disadvantageous in that plant fragments absorb water and swell during the micronization process, so as to stop the micronization; a large amount of plants cannot be processed at once for at least the same reason. Hence, wet micronization in oil/fat is used in one or more embodiments in view of the above.

The oil/fat composition of one or more embodiments may be obtained through wet micronization of plant homogenates together with an oil/fat, and the plant can be dried and coarsely pulverized prior to the wet micronization. The drying method may not be limited as long as it is generally employed for drying foods, and examples thereof include sun drying, shade drying, freeze drying, air drying (hot air drying, fluidized bed drying method, spray drying, drum drying, low temperature drying, etc.), pressure drying, vacuum drying, microwave drying, oil heat-drying, etc. Air drying (particularly drying at normal temperature or quick hot air drying in view of minimizing changes in quality) or freeze drying are employed because these methods allow easy adjustment of water content regardless of materials and are convenient for industrial mass processing.

The above coarse pulverization method is not particular limited as long as it is a means capable of processing foods with a high shearing force in a short time. Examples of such methods may be any instruments referred to as a blender, a mixer, a mill machine, a kneader, a pulverizer, a disintegrator, a grinding mill and the like. The coarse pulverization method may be any of dry pulverization and wet pulverization, and may be any of high temperature pulverization, room temperature pulverization, and low temperature pulverization. Of these, dry pulverization and room temperature pulverization may be used in view of work efficiency when used for further pulverization and minimizing changes in quality. The size of the coarsely pulverized powder is not particularly limited as long as it enables subsequent micronization in oil, and the size may be appropriately adjusted.

The lower limit of the weight percentage of the above dried food in the mixture of one or more embodiments of the present invention is 20 mass % or more, 25 mass % or more, or 30 mass % or more, in view of the preferable texture of the overall mixture of one or more embodiments of the present invention. On the other hand, the upper limit is 80 mass % or less, 75 mass % or less, or 70 mass % or less, in view of sufficient embedding or the dried food in the oil/fat.

The lower limit of the weight percentage of the oil/fat composition in the mixture of one or more embodiments of the present invention is 20 mass % or more, 25 mass % or more, or 30 mass % or more, in view of sufficient embedding of the dried food in the oil/fat composition. On the other hand, the upper limit thereof is 80 mass % or less, 75 mass % or less, or 70 mass % or less, in view of the texture of the overall mixture of the oil/fat composition and the dried food.

The volume percentage of the dried food in the whole volume of the mixture of one or more embodiments of the present invention is 25 vol % or more, 30 vol % or more, or 35 vol % or more, in view of the preferable texture of the overall mixture of one or more embodiments of the present invention. On the other hand, the upper limit thereof is 65 vol % or less, 60 vol % or less, or 55 vol % or less, in view of sufficient embedding of the dried food in the oil/fat composition. Regarding a method for measuring the volume percentage, it may be measured by collecting the dried food from the mixture and then measuring using the Archimedes' principle.

In the mixture of one or more embodiments of the present invention, the content of an emulsifier is usually 3 mass % or less, 1 mass % or less, or 0.3 mass % or less. The reason for this is as follows: the oil/fat containing the fine plant particles itself has dispersion homogeneity and a dispersion stabilizing effect; thus even when the oil/fat composition containing the dry fine particles of the plant is mixed with the dried food, the homogeneity is not lost, and hence the dried food is embedded in the oil/fat composition; as a result, an emulsifier is not necessarily required. Moreover, there is a consumer orientation today of avoiding these food additives.

The mixture of one or more embodiments of the present invention contains substantially no water except for trace amounts of water contained in the various raw materials. This is because when water is contained, a plant as the dried food absorbs water to impair the crunchy and crispy textures. Here, the water content is generally 5 mass % or less, 3 mass % or less, or 1 mass % or less.

In the mixture of one or more embodiments of the present invention, the dried food is mixed in the oil/fat composition containing the fine plant particles to embed the whole dried food in the oil/fat composition, so that the dried food is shielded from air and does not absorb water. Therefore, the crunchy and crispy textures unique to the dried food is maintained. In addition, since the dried food is derived from a plant and contains a large amount of hygroscopic components, the dried food has a good property for absorbing water, but has a weak property for absorbing oil/fat. Hence, the crunchy and crispy textures specific to the dried food are not altered by the oil/fat composition. Therefore, the mixture of one or more embodiments of the present invention does not particularly require heat sterilization. In the mixture of one or more embodiments of the present invention, no dry food particles were visually observed as being exposed directly and completely on the surface of the oil/fat composition.

Therefore, when one eats the mixture of one or more embodiments of the present invention, (s)he can feel the smooth fluidity of the oil/fat composition and the crunchy and crispy textures of the dried food embedded therein simultaneously in the oral cavity. Furthermore, since the oil/fat composition contains the above fine plant particles, thick and favorable aroma and taste derived from the raw-material plant instantly spread as the collapse of the fine particles coated with the oil/fat film in the oral cavity. Hence, one can enjoy the crunchy and crispy textures of the dried food as a comfortable stimulus, while feeling rich and smooth flavor and smooth physical properties of the oil/fat composition. Overall, one can eat the mixture while feeling its improved taste and texture.

One or more embodiments of the present invention also includes an embodiment which is prepared by mixing the above mixture of a food and an oil/fat (the mixture of one or more embodiments of the present invention) with a sugar solution having a water content of 10 mass % or more and 40 mass % or less, and then evaporating excessive water by heat-drying for solidification (this embodiment may also be referred to as a solidified product of one or more embodiments of the mixture of the present invention).

The solidified product of the mixture of one or more embodiments of the present invention is a solid product obtained by solidifying the whole mixture with a sugar solution, unlike the above mixture of one or more embodiments of the present invention having fluidity, and is an embodiment having no fluidity but additional convenient eatability, unlike the former mixture.

Since the mixture of one or more embodiments of the present invention assumes fluidity, one can eat it by pushing out of a bag or a tube, by scooping with a spoon from a container, or by applying it to or spreading it over other foods. On the other hand, since this solid product is solid, one can directly bite or lick the solid product while holding it by hands. Hence, it can be said that the solid product is an embodiment having increased immediate eatability compared to the former mixture.

The sugar solution can be mixed with the mixture of one or more embodiments of the present invention for solidifying through heat-drying to evaporate excess water. Since the mixture of one or more embodiments of the present invention is prepared by using plant-derived raw materials, the sugar solution is a plant-derived juice (including fruit juice) or sap, or a purified product thereof, and further a concentrate thereof in view of compatibility between raw materials. Specifically, the water content of the sugar solution may be 10 mass % or more, and in view of the easiness of homogenization upon mixing, aggregation/shape-keeping effect of raw materials other than the dried food and the oil/fat composition, the water content or the sugar solution is 12.5 mass % or more, or 15 mass % or more. On the other hand, the upper limit thereof may be 40 mass % or less, and in view of preventing the deterioration of the flavor/physical properties of the dried food due to water, and in view of suppressing the deterioration of the flavor of the mixture of the dried food and the oil/fat composition due to the shortened heating time, the upper limit is 37.5 mass % or less, or 35 mass % or less.

More specifically, the plant-derived juice (including fruit juice) or sap, which is the sugar solution, a purified product thereof or a concentrate thereof, may be derived from one or more materials selected from the group consisting of a concentrated juice of a fruit, a date, a sugar cane, a maple and a honey in view of the flavor, sugar concentration and composition. The lower limit of the sugar content of such sugar solution is 25 mass %.

The sugar solution contains water as described above, and the solution may be subjected to heat-drying in such a manner that excess water is evaporated until the mixture of the dried food and the oil/fat composition is solidified. Even during drying immediately after mixing with the sugar solution and even when a certain amount of water remains in the final solidified product after drying and solidification, the dried food in the mixture of the oil/fat composition and the dried food is embedded in the oil/fat composition having high temperature resistance and good homogeneous stability, and thus the embedding state created by these procedures from mixing of raw materials to solidification by heat-drying is maintained and the unique crunchy and crispy textures are not impaired.

Accordingly, the low degree of heat-drying may be sufficient for raw materials other than the dried food and the oil/fat composition to be able to have moist texture. Therefore, due to such a low degree of heat-drying, the degree of thermal decomposition of nutritional elements contained in the fine plant particles contained in the plant-derived dried food and the oil/fat composition is also low, so that a food in which raw-material-derived nutritional elements are sufficiently maintained can be obtained.

Accordingly, when one eats the solidified product of the mixture of one or more embodiments of the present invention, (s)he can simultaneously feel the moist texture of the oil/fat composition and portions other than the dried food solidified with the sugar solution and the crunchy and crispy textures of the dried food embedded therein in the oral cavity, which are the same as those in the case of the mixture of the dried food and the oil/fat composition. Specifically, thick and favorable aroma and taste derived from the raw-material plant instantly spread as the collapse of the fine particles coated with the oil/fat film of the oil/fat composition in the oral cavity. Hence, one can enjoy the crunchy and crispy textures of the dried food as a comfortable stimulus, while feeling rich and smooth flavor and smooth physical properties of the oil/fat composition and the moist texture of raw-material portions other than the dried food. Overall, one can eat the solidified product while feeling improved taste and texture.

In one or more embodiments, the oil/fat composition, the mixture, and the solidified product thereof may contain various foods and food additives, etc., as necessary, which are used. for general foods, in view of maintaining quality and imparting a desired flavor, as long as the action and the effects of one or more embodiments of the present invention are not hindered. Examples thereof can include vinegar, a common salt, soy sauce, miso, an alcohol, an amino acid, a sugar (glucose, sucrose, fructose, glucose fructose liquid sugar, fructose glucose liquid sugar), a sugar alcohols (xylitol, erythritol, maltitol), artificial sweeteners (sucralose, aspartame, saccharin, acesulfame K), minerals (calcium, potassium, sodium, iron, zinc, magnesium, etc., and their salts), flavors, pH adjusters (sodium hydroxide, potassium hydroxide, lactic acid, citric acid, tartaric acid, malic acid, and acetic acid, etc.), cyclodextrin, an antioxidant (vitamin E, vitamin C, tea extract, fresh coffee bean extract, chlorogenic acid, spice extract, caffeic acid, rosemary extract, vitamin C palmitate, rutin, quercetin, bayberry extract, sesame extract etc.), various plant-derived powders, and a processed product derived from an edible plant such as various plant-derived pastes. Further, an emulsifier (glycerin fatty acid ester, acetic acid monoglyceride, lactic acid monoglyceride, citric acid monoglyceride, diacetyltartaric acid monoglyceride, succinic acid monoglyceride, polyglycerin fatty acid ester, polyglycerin condensed linosyl acid ester, Quillaja extract, soybean saponin, tea seed saponin, sucrose fatty acid ester) and a coloring agent can also be added. However, due to the recent increase in natural orientation, the quality such that no emulsifier and/or no coloring agent is added is desirable, and the quality such that general food additives (e.g., those listed in Indication of Food Additives, Pocket Book (2016 Edition)) are not contained is most desirable.

Since the solidified product of the mixture of one or more embodiments of the present invention is solidified (e.g., one can eat the product in various massive forms including a bar shape, a stick shape, a cookie shape, a granular shape, a block shape, etc.), unlike the mixture of the dried food and the oil/fat composition, the product requires no tableware and the like and can be provided as an embodiment with improved eatability excellent with immediate eatability.

One or more embodiments of the present invention also relate to a method for producing the mixture of a food and an oil/fat, and the method includes mixing the dried food with an oil/fat composition to embed the dried food in the oil/fat composition, the oil/fat composition being prepared by drying a plant raw material for the plant-derived oil/fat composition, coarsely pulverizing the resultant, mixing the pulverized product with plant-derived oil/fat having fluidity at 20° C., and then subjecting the mixture to micronization together with the oil/fat using a wet medium stirring mill.

One or more embodiments of the present invention also relate to a method for producing a solidified mixture of a food and an oil/fat and the method includes adding a sugar composition having a water content of 10 mass % or more and 40 mass % or less to the mixture of the food and the oil/fat, mixing the resultant, and then heat-drying the mixture for solidification.

Moreover, one or more embodiments of the present invention also relate to a method for retaining the texture and the flavor of the mixture of a food and an oil/fat, and the method includes mixing the dried food with an oil/fat composition to embed the dried food in the oil/fat composition, the oil/fat composition being prepared by drying a plant raw material for the plant-derived oil/fat composition, coarsely pulverizing the resultant, mixing the pulverized product with plant-derived oil/fat having fluidity at 20° C., and then subjecting the mixture to micronization together with the oil/fat using a wet medium stirring mill.

One or more embodiments of the present invention also relate to a method for improving eatability of a mixture of a food and an oil/fat while retaining texture and flavor through solidification, and the method includes adding a sugar solution having a water content of 10 mass % or more and 40 mass % or less to a mixture of a food and an oil/fat, mixing the resultant, and then heat-drying the mixture for solidification.

### EXAMPLES

Hereinafter, one or more embodiments of the present invention will be described with reference to examples, but the present invention is not limited thereto.

### [Example 1] Verification of a Method for Maintaining the Texture and the Flavor of Dried Foods

Here, the method for maintaining the texture and flavor of the dried food(s) of one or more embodiments of the present invention was compared with conventional techniques for verification. According to each method shown in Table 1, the dried foods were mixed with each of various solvents, the mixture was left to stand for 2 hours under conditions of an atmospheric temperature of 20° C and a humidity of 60%, and then the effects on the texture and flavor of the dried foods were evaluated. Six professional panelists made evaluation and scored according to the following evaluation criteria (the results were rounded off to the nearest decimal place).

### Evaluation Criterion 1: Texture of Dried Foods

5: Crunchy and crispy, significantly preferable.
4: Slightly crunchy and crispy, preferable.
3: Feel moist, but acceptable.
2: Slightly soft, boneless texture, unpreferable.
1: Soft, boneless texture, significantly unpreferable.

### Evaluation Criterion 2: Flavor of Dried Food

5: Strong original flavor, significantly preferable.
4: Slightly strong original flavor, preferable.
3: Slightly weak original flavor, but acceptable.
2: Slightly weak original flavor, unpreferable.
1: Weak original flavor, significantly unpreferable.

### Evaluation Criterion 3: Overall Evaluation

5: Significantly superior.

### 4: Superior.

### 3: Acceptable.

2: inferior.
1: Significantly inferior.

Results are shown in Table 1.

TABLE 1

| | Comparative | Comparative | Comparative | Comparative | |
|---|---|---|---|---|---|
| | example 1 | example 2 | example 3 | example 4 | Test example 1 |
| Solvent | Water | Milk | Sugar solution | Olive oil | Oil/fat composition |
| Composition | Water | Water | Date-derived | Oil/fat 100% | Containing 40% |
| | content 100% | content 87% | concentrated juice | | beet powder (60% |
| | | | (water content 20%) | | olive oil) |
| Mixing proportion | 80 | 80 | 80 | 80 | 80 |
| (weight percentage, %) | | | | | |
| Dried foods | Quinoa puff | Quinoa puff | Quinoa puff | Quinoa puff | Quinoa puff |
| | Raisin | Raisin | Raisin | Raisin | Raisin |
| | Carrot chips | Carrot chips | Carrot chips | Carrot chips | Carrot chips |
| Mixing proportion | 20 | 20 | 20 | 20 | 20 |
| (weight percentage, %) | | | | | |
| Mixing proportion | 40 | 40 | 40 | 40 | 40 |
| (volume percentage, %) | | | | | |
| Texture | 1 | 1 | 2 | 3 | 5 |
| Flavor | 1 | 1 | 2 | 4 | 5 |
| Overall evaluation | 1 | 1 | 2 | 2 | 5 |
| (including remarks) | | | | | |
| Remarks | Dried foods | Dried foods | Dried foods absorbed | Dried foods floated on the | Dried foods were |
| | absorbed water | absorbed water | water despite low | top of the solvent, leading | homogeneously |
| | and thus sunk | and thus sunk | water content, | to poor homogeneity, and | embedded in the |
| | in the solvent. | in the solvent. | impairing texture | the oil film had low | solvent. |
| | | | and flavor. | viscosity, causing potions | |
| | | | | floating on the top to get | |
| | | | | moist. | |

As a result, when the dried foods were mixed with a solvent containing a large amount of water (Comparative Examples 1 and 2), the dried foods absorbed water, and then sunk into the solvent, damaging both texture and flavor significantly. Further, in a sugar solution having a relatively low water content and high viscosity (Comparative Example 3), the dried foods absorbed water despite of its low water content, damaging texture and flavor. In addition, when mixed with a 100% oil/fat solvent (Comparative Example 4), texture and flavor were not impaired, but the dried foods floated on the top of the solvent and the mixture was poor in homogeneity. Therefore, the overall evaluation was low. On the other hand, when the dried foods were mixed with the oil/fat composition obtained by mixing coarsely pulverized beets with olive oil and then subjecting the mixture to wet micronization using a medium stirring mill (bead mill) (Test Example 1), both the texture and the flavor of the dried foods were not impaired, the dried foods were embedded in the oil/fat composition, and the resultant was excellent in homogeneity. Homogeneity is considered to be an important factor because of the effect of maintaining a constant flavor balance among every meals upon eating. In conclusion, the oil/fat composition of Test Example 1 exhibiting homogeneity while maintaining texture and flavor was the most suitable for preparing a mixture of the dried foods. At this time, homogeneity was achieved without using any emulsifier. Further, it is clear that the mixture of Test Example 1 was substantially free of water due to the composition.

### [Example 2] Verification of the Average Particle Diameter Range of fine Plant Particles Contained in Oil/Fat Compositions

In Example 1, it was found that the oil/fat composition is good as a solvent for mixing with dried foods. Hence, the average particle diameter range of fine plant particles contained in the oil/fat compositions was verified.

Fine plant particles having different average particle diameters were prepared by coarsely pulverizing a dry plant to obtain a coarsely pulverized product using a dry pulverizer, or by further treating the coarsely pulverized product with a medium stirring mill (bead mill) having different bead diameters. The term “average particle diameter” as used herein refers to d50. Specific average particle diameters of the oil/fat compositions having different average particle diameters are as shown in Table 2. The average particle diameter of fine plant particles was measured using a laser diffraction particle size distribution analyzer (Microtrac MT3300 EXII system manufactured by MicrotracBEL Corp.), distilled water as a solvent upon measurement, DMS2 (Data Management System version 2, MicrotracBEL Corp.) as measurement application software, and “particle diameter (d50)”.

These prepared oil/fat compositions were mixed with dried foods in the same manner as in Example 1, and then the texture and the flavor of the dried foods in the mixtures were evaluated. Evaluation was performed in the same manner as in Example 1. Dried food particles completely exposed on the oil/fat composition surface were not observed, so as to visually confirm that dried food particles were embedded in the oil/fat compositions.

Results are shown in Table 2.

TABLE 2

| | Comparative | Test | Test | Test | Test | Test |
|---|---|---|---|---|---|---|
| | example 5 | example 2 | example 3 | example 4 | example 5 | example 6 |
| Solvent | Oil/fat | Oil/fat | Oil/fat | Oil/fat | Oil/fat | Oil/fat |
| | composition | composition | composition | composition | composition | composition |
| Composition | Containing 40% | Containing 40% | Containing 40% | Containing 40% | Containing 40% | Containing 40% |
| | beet powder | beet powder | beet powder | beet powder | beet powder | beet powder |
| | (60% olive oil) | (60% olive oil) | (60% olive oil) | (60% olive oil) | (60% olive oil) | (60% olive oil) |
| Average particle | 0.1 | 0.3 | 0.5 | 1.0 | 5 | 10 |
| diameter of beet | | | | | | |
| powder (μm) | | | | | | |
| Mixing proportion | 80 | 80 | 80 | 80 | 80 | 80 |
| (weight | | | | | | |
| percentage, %) | | | | | | |
| Dried foods | Quinoa puff | Quinoa puff | Quinoa puff | Quinoa puff | Quinoa puff | Quinoa puff |
| | Raisin | Raisin | Raisin | Raisin | Raisin | Raisin |
| | Carrot chips | Carrot chips | Carrot chips | Carrot chips | Carrot chips | Carrot chips |
| Mixing proportion | 20 | 20 | 20 | 20 | 20 | 20 |
| (weight | | | | | | |
| percentage, %) | | | | | | |
| Mixing proportion | 40 | 40 | 40 | 40 | 40 | 40 |
| (volume | | | | | | |
| percentage, %) | | | | | | |
| Texture | 5 | 5 | 5 | 5 | 5 | 5 |
| Flavor | 5 | 5 | 5 | 5 | 5 | 5 |
| Overall evaluation | 2 | 3 | 4 | 5 | 5 | 5 |
| (including remarks) | | | | | | |
| Remarks | Dried foods | Dried foods | Dried foods | Dried foods | Dried foods | Dried foods |
| | were embedded | were embedded | were embedded | were embedded | were embedded | were embedded |
| | homogeneously | homogeneously | homogeneously | homogeneously | homogeneously | homogeneously |
| | in the solvent, | in the solvent, | in the solvent, | in the solvent. | in the solvent. | in the solvent. |
| | but the treatment | but the treatment | but the treatment | | | |
| | required to | required to | required to | | | |
| | achieve the | achieve the | achieve the | | | |
| | particle diameter | particle diameter | particle diameter | | | |
| | took significant | took some effort | took some time. | | | |
| | effort and time. | and time. | | | | |

| | Test | Test | Test | Test | Comparative |
|---|---|---|---|---|---|
| | example 7 | example 8 | example 9 | example 10 | example 6 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 15 | 20 | 25 | 30 | 35 |
| diameter of beet | | | | | |
| powder (μm) | | | | | |
| Mixing proportion | 80 | 80 | 80 | 80 | 80 |
| (weight | | | | | |
| percentage, %) | | | | | |
| Dried foods | Quinoa puff | Quinoa puff | Quinoa puff | Quinoa puff | Quinoa puff |
| | Raisin | Raisin | Raisin | Raisin | Raisin |
| | Carrot chips | Carrot chips | Carrot chips | Carrot chips | Carrot chips |
| Mixing proportion | 20 | 20 | 20 | 20 | 20 |
| (weight | | | | | |
| percentage, %) | | | | | |
| Mixing proportion | 40 | 40 | 40 | 40 | 40 |
| (volume | | | | | |
| percentage, %) | | | | | |
| Texture | 5 | 5 | 5 | 5 | 5 |
| Flavor | 5 | 5 | 5 | 5 | 5 |
| Overall evaluation | 5 | 5 | 4 | 3 | 2 |
| (including remarks) | | | | | |
| Remarks | Dried foods | Dried foods | Only a small | A small portion | Graininess of |
| | were embedded | were embedded | portion of the | of the dried | the oil/fat |
| | homogeneously | homogeneously | dried foods | foods tended to | composition was |
| | in the solvent. | in the solvent. | tended to float | float on the top | noticed, |
| | | | on the top of the | of the solvent, | indicating poor |
| | | | solvent, but the | but the | smoothness. |
| | | | homogeneity | homogeneity | |
| | | | upon eating was | upon eating was | |
| | | | normal. | acceptable. | |

As a result, in all the test sections, both the texture and the flavor of the dried foods were remarkably excellent. However, when the average particle diameter of the plant powder in the oil/fat composition was 0.1 μm (Comparative Example 5), reducing the particle diameter down to this diameter required many steps of micronization with different bead diameters. Moreover, each step of this process needed a long time, and thus the micronization steps were impractical. Moreover, when the average particle diameter of the plant powder was 35 μm (Comparative Example 6), the oil/fat composition required to be smooth had graininess after taste, which was considered to be derived from the plant powder, indicating its unpreferable quality. Specifically, it was found that the optimum range of the particle diameter of the plant powder in the oil/fat composition may be 0.3 μm or more. However, 0.5 μm or more or 1.0 μm or more may be used in one or more embodiments in view of effort and time required for the treatment and the doubt of the safety of nanomaterials. Meanwhile, it was found that the upper limit may be 30 μm or less. However, it was found that 25 μm or more or 20 μm or more may be used in one or more embodiments, in view of homogeneous dispersibility of the dried foods the oil/fat composition. Further, it is clear that the mixtures of Test Examples 2 to 10 were substantially free of water due to the compositions. Moreover, crunchy and crispy textures unique to the dried foods were exhibited without heat sterilization.

### [Example 3] Verification of the Range of the Contents of Fine Plant Particles Contained in Oil/Fat Compositions

In Example 2, it was found that the average particle diameter of fine plant particles contained in an oil/fat composition may range from 0.3 μm or more to 30 μm or less. Subsequently, here the range of the contents of fine plant particles having particle diameters within this range in oil/fat compositions was verified. Based on the results in Example 2, oil/fat compositions containing beet powder with an average particle diameter of 10 μm were prepared, the oil/fat compositions were mixed with olive oil as shown in Table 3, and then oil/fat compositions containing beet powder in different contents were prepared. Oil/fat compositions in which the content of beet powder was 50 mass % or more were newly prepared according to Example 1.

The dried foods were mixed in the same manner as in Example 1, and then the texture and the flavor etc., of the dried foods in the mixtures were evaluated. Evaluation was performed in the same manner as in Example 1. The oil/fat composition surface was observed so as to visually confirm that all the dried food particles were embedded in the oil/fat compositions.

Results are shown in Table 3.

TABLE 3

| | Comparative | Test | Test | Test | Test | Test |
|---|---|---|---|---|---|---|
| | example 7 | example 11 | example 12 | example 13 | example 14 | example 15 |
| Solvent | Oil/fat | Oil/fat | Oil/fat | Oil/fat | Oil/fat | Oil/fat |
| | composition | composition | composition | composition | composition | composition |
| Composition | Containing 40% | Containing 40% | Containing 40% | Containing 40% | Containing 40% | Containing 40% |
| | beet powder | beet powder | beet powder | beet powder | beet powder | beet powder |
| | (60% olive oil) | (60% olive oil) | (60% olive oil) | (60% olive oil) | (60% olive oil) | (60% olive oil) |
| Average particle | 10 | 10 | 10 | 10 | 10 | 10 |
| diameter of beet | | | | | | |
| powder (μm) | | | | | | |
| Beet powder content | 5 | 10 | 15 | 20 | 30 | 40 |
| (weight | | | | | | |
| percentage, %) | | | | | | |
| Olive oil content | 95 | 90 | 85 | 80 | 70 | 60 |
| (weight | | | | | | |
| percentage, %) | | | | | | |
| Mixing proportion | 80 | 80 | 80 | 80 | 80 | 80 |
| (weight | | | | | | |
| percentage, %) | | | | | | |
| Dried foods | Quinoa puff | Quinoa puff | Quinoa puff | Quinoa puff | Quinoa puff | Quinoa puff |
| | Raisin | Raisin | Raisin | Raisin | Raisin | Raisin |
| | Carrot chips | Carrot chips | Carrot chips | Carrot chips | Carrot chips | Carrot chips |
| Mixing proportion | 20 | 20 | 20 | 20 | 20 | 20 |
| (weight | | | | | | |
| percentage, %) | | | | | | |
| Mixing proportion | 40 | 40 | 40 | 40 | 40 | 40 |
| (volume | | | | | | |
| percentage, %) | | | | | | |
| Texture | 5 | 5 | 5 | 5 | 5 | 5 |
| Flavor | 5 | 5 | 5 | 5 | 5 | 5 |
| Overall evaluation | 2 | 3 | 4 | 5 | 5 | 5 |
| (including remarks) | | | | | | |
| Remarks | A portion of the | A small portion | Only a small | The dried foods | The dried foods | The dried foods |
| | dried foods | of the dried | portion of the | were embedded | were embedded | were embedded |
| | floated on the | foods tended to | dried foods | homogeneously | homogeneously | homogeneously |
| | top of the | float on the top | tended to float | in the solvent. | in the solvent. | in the solvent. |
| | solvent, | of the solvent, | on the top of | | | |
| | indicating poor | out the | the solvent, but | | | |
| | homogeneity. | homogeneity | the | | | |
| | | upon eating was | homogeneity | | | |
| | | acceptable. | upon eating was | | | |
| | | | normal. | | | |
| | Test | Test | Test | Test | Test | Comparative |
| | example 16 | example 17 | example 18 | example 19 | example 20 | example 8 |
| Solvent | Oil/fat | Oil/fat | Oil/fat | Oil/fat | Oil/fat | Oil/fat |
| | composition | composition | composition | composition | composition | composition |
| Composition | Containing 50% | Containing 60% | Containing 70% | Containing 75% | Containing 80% | Containing 85% |
| | beet powder | beet powder | beet powder | beet powder | beet powder | beet powder |
| | (50% olive oil) | (40% olive oil) | (30% olive oil) | (25% olive oil) | (20% olive oil) | (15% olive oil) |
| Average particle | 10 | 10 | 10 | 10 | 10 | 10 |
| diameter of beet | | | | | | |
| powder (μm) | | | | | | |
| Beet powder content | 50 | 60 | 70 | 75 | 80 | 85 |
| (weight | | | | | | |
| percentage, %) | | | | | | |
| Olive oil content | 50 | 40 | 30 | 25 | 20 | 15 |
| (weight | | | | | | |
| percentage, %) | | | | | | |
| Mixing proportion | 80 | 80 | 80 | 80 | 80 | 80 |
| (weight | | | | | | |
| percentage, %) | | | | | | |
| Dried foods | Quinoa puff | Quinoa puff | Quinoa puff | Quinoa puff | Quinoa puff | Quinoa puff |
| | Raisin | Raisin | Raisin | Raisin | Raisin | Raisin |
| | Carrot chips | Carrot chips | Carrot chips | Carrot chips | Carrot chips | Carrot chips |
| Mixing proportion | 20 | 20 | 20 | 20 | 20 | 20 |
| (weight | | | | | | |
| percentage, %) | | | | | | |
| Mixing proportion | 40 | 40 | 40 | 40 | 40 | 40 |
| (volume | | | | | | |
| percentage, %) | | | | | | |
| Texture | 5 | 5 | 5 | 5 | 5 | 5 |
| Flavor | 5 | 5 | 5 | 5 | 5 | 5 |
| Overall evaluation | 5 | 5 | 4 | 3 | 3 | 2 |
| (including remarks) | | | | | | |
| Remarks | The dried foods | The dried foods | Homogenous | Homogenous | Homogenous | Micronization |
| | were embedded | were embedded | dispersing of | dispersing of | dispersing of | of plant powder |
| | homogeneously | homogeneously | the dried foods | the dried foods | the dried foods | took much |
| | in the solvent. | in the solvent. | required some | required effort | required effort | time. |
| | | | effort because | because of high | because of high | |
| | | | of slightly high | viscosity, but | viscosity, but | |
| | | | viscosity, but | this was | this was | |
| | | | this was not | acceptable. | acceptable. | |
| | | | problematic. | | | |

As a result, in all the test sections, both the texture and the flavor of the dried foods were remarkably excellent. However, when the weight percentage of the plant powder in the oil/fat composition was 5 mass % (Comparative Example 7), a portion of the dried foods floated on the top of the solvent, indicating poor homogeneity. Moreover, when the weight percentage of the plant powder in the oil/fat composition was 85 mass % (Comparative Example 8), the viscosity was very high, indicating impractical quality. Hence, it was found that the optimum range of the weight percentages of the plant powder in the oil/fat compositions may be 10 mass % or more. However, it was found that 15 mass % or more, or 20 mass % or more may be used in one or more embodiments in view of homogeneity of the dried foods in the oil/fat composition. On the other hand, it was found that the upper limit may be 80 mass % or less. However, it was found that 70 mass % or less, or 60 mass % or less may be used in one or more embodiments in view of the ease of homogenous mixing of the dried foods. Further, in this test, homogeneity was achieved without using any emulsifier. It is clear that the mixtures of these Test Examples 11 to 20 were substantially free of water due to the composition. Further, crunchy and crispy textures unique to the dried foods were exhibited without heat sterilization.

### [Example 4] Verification of the Range of the Mixing Proportions of Dried Foods And Oil/Fat Compositions in Mixtures of the Foods and Oils/Fats

Here, the optimum range of the mixing proportions of the dried foods and oil/fat compositions in the mixtures of the foods and oils/fats was verified. As shown in Table 4, the mixing proportions of the dried foods and the oil/fat compositions were varied to evaluate the texture and the flavor etc., of the dried foods in the mixtures and the overall taste of the mixtures of the foods and the oils/fats (Evaluation Criterion 4). Further, based on the results of Example 2, oil/fat compositions containing beet powder having an average particle diameter of 10 μm were prepared. Based on the result of Example 3, the weight percentage of the beet powder in the oil/fat composition was 40 mass %. Except for Evaluation criterion 4, the dried foods were mixed and then evaluated in the same manner as in Example 1. Evaluation was performed in the same manner as in Example 1. The dried food particles completely exposed on the oil-fat composition surface were not observed, so as to visually confirm that the dried food particles were embedded in the oil/fat compositions.

### Evaluation Criterion 4: Overall Taste of Mixture of Food and Oil/Fat

5: Crunchy and crispy textures of the dried foods matched the taste and smoothness of the oil/fat composition in a balanced manner. Significantly preferable.
4: Crunchy and crispy textures of the dried foods matched the taste and smoothness of the oil/fat composition is a slightly balanced manner. Preferable.
3: Balance between the crunchy and crispy textures of the dried foods and the taste and smoothness of the oil/fat composition was acceptable.
2: Balance between the crunchy and crispy textures of the dried foods and the taste and smoothness of the oil/fat composition was slightly bad. Unpreferable.
1: Balance between the crunchy and crispy textures of the dried foods and the taste and smoothness of the oil/fat composition was bad. Significantly unpreferable.

Results are shown in Table 4.

TABLE 4

| | Comparative | Test | Test | Test | Test | Test |
|---|---|---|---|---|---|---|
| | example 9 | example 21 | example 22 | example 23 | example 24 | example 25 |
| Solvent | Oil/fat | Oil/fat | Oil/fat | Oil/fat | Oil/fat | Oil/fat |
| | composition | composition | composition | composition | composition | composition |
| Composition | Containing 40% | Containing 40% | Containing 40% | Containing 40% | Containing 40% | Containing 40% |
| | beet powder | beet powder | beet powder | beet powder | beet powder | beet powder |
| | (60% olive oil) | (60% olive oil) | (60% olive oil) | (60% olive oil) | (60% olive oil) | (60% olive oil) |
| Average particle | 10 | 10 | 10 | 10 | 10 | 10 |
| diameter of beet | | | | | | |
| powder (μm) | | | | | | |
| Beet powder content | 40 | 40 | 40 | 40 | 40 | 40 |
| (weight | | | | | | |
| percentage, %) | | | | | | |
| Olive oil content | 60 | 60 | 60 | 60 | 60 | 60 |
| (weight | | | | | | |
| percentage, %) | | | | | | |
| Mixing proportion | 85 | 80 | 75 | 70 | 60 | 50 |
| (weight | | | | | | |
| percentage, %) | | | | | | |
| Dried foods | Quinoa puff | Quinoa puff | Quinoa puff | Quinoa puff | Quinoa puff | Quinoa puff |
| | Raisin | Raisin | Raisin | Raisin | Raisin | Raisin |
| | Carrot chips | Carrot chips | Carrot chips | Carrot chips | Carrot chips | Carrot chips |
| Mixing proportion | 15 | 20 | 25 | 30 | 40 | 50 |
| (weight | | | | | | |
| percentage, %) | | | | | | |
| Texture of | 5 | 5 | 5 | 5 | 5 | 5 |
| dried foods | | | | | | |
| Flavor of | 5 | 5 | 5 | 5 | 5 | 5 |
| dried foods | | | | | | |
| Taste of overall | 2 | 3 | 4 | 5 | 5 | 5 |
| mixture of | | | | | | |
| foods and oil/fat | | | | | | |
| Overall evaluation | 2 | 3 | 4 | 5 | 5 | 5 |
| (including remarks) | | | | | | |
| Remarks | Dried food content | Dried food | Dried food | Dried foods | Dried foods | Dried foods |
| | was excessively | content was | content was | were embedded | were embedded | were embedded |
| | low, resulting in the | lower, but the | slightly lower, | homogeneously | homogeneously | homogeneously |
| | lack of the texture. | texture was | but it caused no | in the solvent, | in the solvent, | in the solvent, |
| | | acceptable. | significant | and the texture | and the texture | and the texture |
| | | | effect. | of the dried | of the dried | of the dried |
| | | | | foods was | foods was | foods was |
| | | | | excellent in | excellent in | excellent in |
| | | | | homogeneity | homogeneity | homogeneity |
| | | | | and strength. | and strength. | and strength. |

| | Test | Test | Test | Test | Comparative |
|---|---|---|---|---|---|
| | example 26 | example 27 | example 28 | example 29 | example 10 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 10 | 10 | 10 | 10 | 10 |
| diameter of beet | | | | | |
| powder (μm) | | | | | |
| Beet powder content | 40 | 40 | 40 | 40 | 40 |
| (weight | | | | | |
| percentage, %) | | | | | |
| Olive oil content | 60 | 60 | 60 | 60 | 60 |
| (weight | | | | | |
| percentage, %) | | | | | |
| Mixing proportion | 40 | 30 | 25 | 20 | 15 |
| (weight | | | | | |
| percentage, %) | | | | | |
| Dried foods | Quinoa puff | Quinoa puff | Quinoa puff | Quinoa puff | Quinoa puff |
| | Raisin | Raisin | Raisin | Raisin | Raisin |
| | Carrot chips | Carrot chips | Carrot chips | Carrot chips | Carrot chips |
| Mixing proportion | 60 | 70 | 75 | 80 | 85 |
| (weight | | | | | |
| percentage, %) | | | | | |
| Texture of | 5 | 5 | 4 | 4 | 3 |
| dried foods | | | | | |
| Flavor of | 5 | 5 | 5 | 4 | 3 |
| dried foods | | | | | |
| Taste of overall | 5 | 5 | 4 | 3 | 2 |
| mixture of | | | | | |
| foods and oil/fat | | | | | |
| Overall evaluation | 5 | 5 | 4 | 3 | 2 |
| (including remarks) | | | | | |
| Remarks | Dried foods | Dried foods | The amount of | The amount of | The amount of |
| | were embedded | were embedded | the oil/fat | the oil/fat | the oil/fat |
| | homogeneously | homogeneously | composition was | composition was | composition was |
| | in the solvent, | in the solvent, | slightly lower, | lower, and the | excessively low, |
| | and the texture | and the texture | but it caused no | degree of | and thus the |
| | of the dried | of the dried | significant | embedding of | dried foods were |
| | foods was | foods was | effect. | the dried foods | not sufficiently |
| | excellent in | excellent in | | was slightly | embedded. |
| | homogeneity | homogeneity | | weak, but was | |
| | and strength. | and strength. | | acceptable. | |

As a result, it was found that the weight percentage of the dried foods may be 20 mass % or more (the weight percentage of the oil/fat composition is 80 mass % or less). However, in view of the balance of the texture and the flavor strength derived from the dried foods in the taste of the overall mixture, 25 mass % or more (the weight percentage of the oil/fat composition is 75% or less), and 30 mass % or more (the weight percentage of the oil/fat composition is 70 mass % or less) is more preferable. On the other hand, it was found that the upper limit of the weight percentage of the dried foods may be 80 mass % or less (the weight percentage of the oil/fat composition is 20 mass % or more). However, in view of maintaining the texture and the flavor through sufficient embedding of the dried foods in the oil/fat composition, 75 mass % or less (the weight percentage of the oil/fat composition is 25 mass % or more), or 70 mass % or less (the weight percentage of the oil/fat composition is 30 mass % or more) may be used in one or more embodiments. Further, it is clear that the mixtures of Test Examples 21 to 29 were substantially free of water due to the composition. Further, crunchy and crispy textures unique to the dried foods were exhibited without heat sterilization.

### [Example 5] Verification of the Range of the Volume Percentages of Dried Foods in Mixtures of Foods and Oils/Fats

In Example 4, the range of the weight percentages of the dried foods in the mixtures of the foods and oils/fats was verified. However, the dried foods were varied in types, specifically in bulk specific gravity ranging from high to low gravities, and the total volume of these dried foods has a great impact upon embedding of the dried foods in the oil/fat composition. Therefore, the optimum range of the volume percentages of the dried foods in the mixture of the foods and the oil/fat was verified.

The types and amounts of dried foods each differing in bulk specific gravity were combined to prepare the mixtures of the foods and the oils/fats having volume percentages as shown in Table 5 and then the mixtures were evaluated in the same manner as in Examples 1 and 4. The oil/fat composition surface was observed so as to visually confirm that all the dried food particles were embedded in the oil/fat compositions.

Results are shown in Table 5.

TABLE 5

| | Comparative | Test | Test | Test | Test |
|---|---|---|---|---|---|
| | example 11 | example 30 | example 31 | example 32 | example 34 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 10 | 10 | 10 | 10 | 10 |
| diameter of beet | | | | | |
| powder (μm) | | | | | |
| Beet powder content | 40 | 40 | 40 | 40 | 40 |
| (weight | | | | | |
| percentage, %) | | | | | |
| Olive oil content | 60 | 60 | 60 | 60 | 60 |
| (weight | | | | | |
| percentage, %) | | | | | |
| Mixing proportion | 80 | 75 | 70 | 65 | 60 |
| (volume | | | | | |
| percentage, %) | | | | | |
| Dried foods (types and | Quinoa puff | Quinoa puff | Quinoa puff | Quinoa puff | Quinoa puff |
| amounts were combined | Raisin | Raisin | Raisin | Raisin | Raisin |
| adequately) | Carrot chips | Carrot chips | Carrot chips | Carrot chips | Carrot chips |
| Mixing proportion | 20 | 25 | 30 | 35 | 40 |
| (volume | | | | | |
| percentage, %) | | | | | |
| Texture of dried foods | 5 | 5 | 5 | 5 | 5 |
| avor of dried foods | 5 | 5 | 5 | 5 | 5 |
| Taste of overall | 2 | 3 | 4 | 5 | 5 |
| mixture of | | | | | |
| foods and oil/fat | | | | | |
| Overall evaluation | 2 | 3 | 4 | 5 | 5 |
| (including remarks) | | | | | |
| Remarks | The amount of | The amount of | The amount of | The oil/fat | The oil/fat |
| | the oil/fat | the oil/fat | the oil/fat | composition was | composition was |
| | composition was | composition was | composition was | embedded | embedded |
| | excessively high, | higher, but the | slightly higher, | homogeneously | homogeneously |
| | resulting in the | strength of | but it caused no | in the solvent, | in the solvent, |
| | lack of the | texture was | significant effect. | and the texture of | and the texture of |
| | strength of | acceptable. | | the dried foods | the dried foods |
| | texture. | | | was excellent in | was excellent in |
| | | | | homogeneity and | homogeneity and |
| | | | | strength. | strength. |
| | Test | Test | Test | Test | Comparative |
| | example 35 | example 36 | example 37 | example 38 | example 12 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 10 | 10 | 10 | 10 | 10 |
| diameter of beet | | | | | |
| powder (μm) | | | | | |
| Beet powder content | 40 | 40 | 40 | 40 | 40 |
| (weight | | | | | |
| percentage, %) | | | | | |
| Olive oil content | 60 | 60 | 60 | 60 | 60 |
| (weight | | | | | |
| percentage, %) | | | | | |
| Mixing proportion | 50 | 45 | 40 | 35 | 30 |
| (volume | | | | | |
| percentage, %) | | | | | |
| Dried foods (types and | Quinoa puff | Quinoa puff | Quinoa puff | Quinoa puff | Quinoa puff |
| amounts were combined | Raisin | Raisin | Raisin | Raisin | Raisin |
| adequately) | Carrot chips | Carrot chips | Carrot chips | Carrot chips | Carrot chips |
| Mixing proportion | 50 | 55 | 60 | 65 | 70 |
| (volume | | | | | |
| percentage, %) | | | | | |
| Texture of dried foods | 5 | 5 | 4 | 4 | 3 |
| avor of dried foods | 5 | 5 | 5 | 4 | 3 |
| Taste of overall | 5 | 5 | 4 | 3 | 2 |
| mixture of | | | | | |
| foods and oil/fat | | | | | |
| Overall evaluation | 5 | 5 | 4 | 3 | 2 |
| (including remarks) | | | | | |
| Remarks | The oil/fat | The oil/fat | The amount of | The amount of | The amount of |
| | composition was | composition was | the dried foods | the dried foods | the dried foods |
| | embedded | embedded | was slightly | was higher, and | was excessively |
| | homogeneously | homogeneously | higher, but it | the degree of | high, and thus the |
| | in the solvent, | in the solvent, | caused no | embedding in the | dried foods were |
| | and the texture of | and the texture of | significant effect. | oil/fat | not sufficiently |
| | the dried foods | the dried foods | | composition was | embedded in the |
| | was excellent in | was excellent in | | slightly weak, but | oil/fat |
| | homogeneity and | homogeneity and | | acceptable. | composition. |
| | strength. | strength. | | | |

As a result, it was found that the volume percentage of the dried foods may be 25 vol % or more. However, it was found that 30 vol % or more, or 35 vol % or more may be used is one or more embodiments in view of the balance of texture and flavor strength derived from the dried foods in the taste of the overall mixture. On the other hand, it was found that the upper limit of the volume percentage of the dried foods may be 65 volume% or less. However, it was found that 60 vol % or less, or 55 vol % or less may be used in one or more embodiments in view of maintaining texture and flavor through sufficient embedding of the dried foods in the oil/fat composition. Moreover, it is clear that the mixtures of Test Examples 30 to 38 were substantially free of water due to the composition. Further, crunchy and crispy textures unique to the dried foods were exhibited without heat sterilization.

### [Example 6] Preparation of Mixtures of Foods and Oils/Fats

According to Examples 1 to 5, conditions for exhibiting crunchy and crispy textures of the dried foods in the mixtures of the foods and the oils/fats, and conditions for exhibiting flavor and a smooth texture derived from the oil/fat composition and texture and flavor strength derived from the dried foods in the taste of the overall mixture in a balanced manner were clarified. Therefore, an examination was conducted here to prepare a product with a higher degree of completion.

According to the formulae described in Table 6, the mixtures of foods and oils/fats were prepared and then the mixtures were evaluated in the same manner as in Examples 1 and 4. Each mixture was eaten in a way such that one eats the mixture by scooping it with a spoon from a cup. Further, dried food particles completely exposed on the oil/fat composition surface were not observed, so as to visually confirm that dried food particles were completely embedded in the oil/fat compositions.

Results are shown in Table 6.

TABLE 6

| | | | Test example 39 | | Test example 40 | |
|---|---|---|---|---|---|---|
| | | | | Proportion | | Proportion |
| | | | Amount | (weight | Amount | (weight |
| Raw materials, etc. | | | mixed (g) | percentage, %) | mixed (g) | percentage, %) |
| Oil/fat | Plant oil/fat | Sesame oil | 430 | 60 | 445 | 63 |
| composition | Plant powder | Coarse beet powder | 140 | 40 | — | 37 |
| (components | | Coarse sweet potato | 80 | | — | |
| listed on the right | | powder | | | | |
| were mixed, | | Coarse Chinese cabbage | 70 | | — | |
| followed by | | powder | | | | |
| micronization | | Green soybean powder | — | | 260 | |

| with medium | Average particle diameter (μm) | 12.3 | 15.6 |
|---|---|---|---|
| stirring mill (bead | Mixing proportion (weight percentage, %) | 72 | 71 |
| mill). | | | |
| Dried foods | Quinoa puff | 40 | 30 |
| | Dried golden berries | 105 | — |
| | Beet chips | 70 | — |
| | Carrot chips | 65 | — |
| | Onion chips | — | 20 |
| | Kidney bean chips | — | 195 |
| | Mixing proportion (weight percentage, %) | 28 | 25 |
| | Mixing proportion (volume percentage, %) | 29 | 63 |
| Others | Cashew nuts paste | — | 49 |
| | White pepper powder | — | 1 |
| Total | | 1000 | 1000 |
| Evaluation results | Flavor of dried foods | 5 | 5 |
| | Texture of dried foods | 5 | 5 |
| | Taste of overall mixture of foods and oil/fat | 5 | 5 |
| | Overall evaluation (including remarks) | 5 | 5 |
| | Remarks | The crunchy and crispy | The crunchy and crispy |
| | | textures of the dried foods | textures of the dried foods |
| | | matched the moist taste, | matched the moist taste, |
| | | smooth texture, and strong | smooth texture, and strong |
| | | flavor of the oil/fat | flavor of the oil/fat |
| | | composition in a balanced | composition in a balanced |
| | | manner, and the color tone | manner, and the color tone |
| | | (vibrant magenta) was good. | (vibrant green) was good. |

As a result, it was found that even in concomitant use of oil/fat compositions and different plant powders, concomitant use of different dried foods, or in a combination with raw materials other than these materials, the action and the effects of one or more embodiments of the present invention were clearly exhibited. Specifically, the crunchy and crispy textures of the dried foods matched the moist taste, smooth texture, and strong flavor of the oil/fat composition in a balanced manner and the color tone was also vivid, demonstrating that the resulting food product enables significantly enjoyable experience of eating. Further, it is clear that the mixtures of Test Examples 39 and 40 were substantially free of water due to the composition. Moreover, crunchy and crispy textures unique to the dried foods were exhibited without heat sterilization.

### [Example 7] Preliminary Examination of Preparation of Solidified Mixtures of Foods and Oils/Fats

In Examples 1 to 6, conditions for preparation of mixtures of foods and oils/fats were examined. As a result, the optimum conditions for preparation and the range thereof were clarified. Therefore, upon an attempt of the solidification of the mixtures, which is an embodiment having improved immediate eatability, the optimum range of the water content of the sugar solution, which is a means thereof, was verified here.

A sugar solution with each water content shown in Table 7 was used and mixed with the above mixture, and then the mixture was heat-dried to evaporate excess water until it was solidified. The solids were evaluated. Evaluation was performed in the same manner as in Examples 1 and 4. The oil/fat composition surface was observed so as to visually confirm that all the dried food particles were embedded in the oil/fat compositions.

Results are shown in Table 7.

TABLE 7

| | Comparative | Test | Test | Test | Test |
|---|---|---|---|---|---|
| | example 13 | example 41 | example 42 | example 43 | example 44 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 10 | 10 | 10 | 10 | 10 |
| diameter of beet | | | | | |
| powder (μm) | | | | | |
| Beet powder content | 40 | 40 | 40 | 40 | 40 |
| (weight | | | | | |
| percentage, %) | | | | | |
| Olive oil content | 60 | 60 | 60 | 60 | 60 |
| (weight | | | | | |
| percentage, %) | | | | | |
| Mixing proportion | 48 | 48 | 48 | 48 | 48 |
| (weight | | | | | |
| percentage, %) | | | | | |
| Dried foods | Quinoa puff | Quinoa puff | Quinoa puff | Quinoa puff | Quinoa puff |
| | Raisin | Raisin | Raisin | Raisin | Raisin |
| | Carrot chips | Carrot chips | Carrot chips | Carrot chips | Carrot chips |
| Mixing proportion | 32 | 32 | 32 | 32 | 32 |
| (weight | | | | | |
| percentage, %) | | | | | |
| Sugar solution | Concentrated | Concentrated | Concentrated | Concentrated | Concentrated |
| | date juice | date juice | date juice | date juice | date juice |
| Water | 7.5 | 10 | 12.5 | 15 | 20 |
| content (wt %) | | | | | |
| Mixing proportion | 20 | 20 | 20 | 20 | 20 |
| (weight | | | | | |
| percentage, %) | | | | | |
| Texture of | 5 | 5 | 5 | 5 | 5 |
| dried foods | | | | | |
| Flavor of | 5 | 5 | 5 | 5 | 5 |
| dried foods | | | | | |
| Taste of overall | 2 | 3 | 4 | 5 | 5 |
| mixture of | | | | | |
| foods and oil/fat | | | | | |
| Overall evaluation | 2 | 3 | 4 | 5 | 5 |
| (including remarks) | | | | | |
| Remarks | Difficult to mix | Slightly | Slightly | Possible to mix | Possible to mix |
| | uniformly with the | difficult to mix | difficult to mix | uniformly with the | uniformly with the |
| | sugar solution; easy | uniformly with the | uniformly with the | sugar solution; easy | sugar solution; easy |
| | to shape before heat | sugar solution; weak | sugar solution; but | to shape before heat | to shape before heat |
| | drying; but weak moist | moist feeling after | moderate moist taste | drying; moderate | drying; moderate |
| | taste and unevenness | solidification was | after solidification were | moist taste after | moist taste after |
| | after solidification | slightly perceived; but | perceived. No problem | solidification | solidification |
| | were perceived, | acceptable quality. | | were perceived. | was perceived. |
| | indicating poor | | | | |
| | quality | | | | |

| | Test | Test | Test | Test | Comparative |
|---|---|---|---|---|---|
| | example 45 | example 46 | example 47 | example 48 | example 14 |
| Solvent | Oil/fat | Oil/fat | Oil/fat | Oil/fat | Oil/fat |
| | composition | composition | composition | composition | composition |
| Composition | Containing 40% | Containing 40% | Containing 40% | Containing 40% | Containing 40% |
| | beet powder | beet powder | beet powder | beet powder | beet powder |
| | (60% olive oil) | (60% olive oil) | (60% olive oil) | (60% olive oil) | (60% olive oil) |
| Average particle | 10 | 10 | 10 | 10 | 10 |
| diameter of beet | | | | | |
| powder (μm) | | | | | |
| Beet powder content | 40 | 40 | 40 | 40 | 40 |
| (weight | | | | | |
| percentage, %) | | | | | |
| Olive oil content | 60 | 60 | 60 | 60 | 60 |
| (weight | | | | | |
| percentage, %) | | | | | |
| Mixing proportion | 48 | 48 | 48 | 48 | 48 |
| (weight | | | | | |
| percentage, %) | | | | | |
| Dried foods | Quinoa puff | Quinoa puff | Quinoa puff | Quinoa puff | Quinoa puff |
| | Raisin | Raisin | Raisin | Raisin | Raisin |
| | Carrot chips | Carrot chips | Carrot chips | Carrot chips | Carrot chips |
| Mixing proportion | 32 | 32 | 32 | 32 | 32 |
| (weight | | | | | |
| percentage, %) | | | | | |
| Sugar solution | Concentrated | Concentrated | Concentrated | Concentrated | Concentrated |
| | date juice | date juice | date juice | date juice | date juice |
| Water | 30 | 35 | 37.5 | 40 | 42.5 |
| content (wt %) | | | | | |
| Milting proportion | 20 | 20 | 20 | 20 | 20 |
| (weight | | | | | |
| percentage, %) | | | | | |
| Texture of | 5 | 5 | 4 | 4 | 3 |
| dried foods | | | | | |
| Flavor of | 5 | 5 | 5 | 4 | 3 |
| dried foods | | | | | |
| Taste of overall | 5 | 5 | 4 | 3 | 2 |
| mixture of | | | | | |
| roods and oil/fat | | | | | |
| Overall evaluation | 5 | 5 | 4 | 3 | 2 |
| (including remarks) | | | | | |
| Remarks | Possible to mix | Possible to mix | Possible to mix | Possible to mix | Possible to mix |
| | uniformly with the | uniformly with the | uniformly with the | uniformly with the | uniformly with the |
| | sugar solution; easy to | sugar solution; easy to | sugar solution; only | sugar solution; a | sugar solution; |
| | shape before heat | shape before heat | a small portion of | portion of the | but the dried foods |
| | drying; moderate | drying; moderate | the dried foods got | dried foods got | got moist, and the |
| | moist taste after | moist taste after | moist; the overall | moist; but the | overall texture and |
| | solidification | solidification | texture and | overall texture and | taste after |
| | were perceived. | was perceived. | taste alter | taste after | solidification |
| | | | solidification | solidification | by heat |
| | | | by heat drying were | by heat drying were | drying were poor. |
| | | | no problem | acceptable. | |

As a result, when the water content in the concentrated date juice as a sugar solution was 7.5 mass % (Comparative Example 13), the viscosity of the sugar solution was so high that uniform mixing was difficult, and the moist feeling was weak after heat-drying and the resultant exhibited unevenness, indicating poor quality. When the water content was 42.5 mass % (Comparative Example 14), the sugar solution was easily mixed uniformly, but in the process, the state of the dried foods embedded in the oil/fat composition was impaired, the dried foods absorbed water to get moist in the mixture, and the texture and flavor were not recovered even after solidification by heat-drying, indicating poor texture and taste. Specifically, it was found that the sugar solution may have a water content of 10 mass % or more. However, it was found that 12.5 mass % or more, or 15 mass % or more may be used in one or more embodiments, in view of retaining uniform mixing of the sugar solution and sufficient moist feeling. Regarding the upper limit, it was found that it may be 40 mass % or less. However, in view of preventing the dried foods from further getting moist and maintaining the original texture, it was found that 37.5 mass % or less or 35 mass % or less may be used in one or more embodiments. In addition, the mixtures of Test Examples 41 to 48, considering the composition, it is clear that they were substantially free of water.

### [Example 8] Examination of Sugar Solution Types

In Example 7, concentrated date juice was used as the sugar solution. It was further examined whether other sugar solutions shown in Table 8 could be solidified. Based on the results of Example 7, each sugar solution was prepared in such a manner that the water content was 20 mass %. Each of solidified mixtures of foods and oils/fats was prepared in the same manner as in Example 7, and then evaluated in the same manner as in Examples 1 and 4. The oil/fat composition surface was observed so as to visually confirm that all the dried food particles were embedded in the oil/fat compositions.

Results are shown in Table 8.

TABLE 8

| | Test example 49 | Test example 50 | Test example 51 | Test example 52 |
|---|---|---|---|---|
| Solvent | Oil/fat compasition | Oil/fat composition | Oil/fat composition | Oil/fat composition |
| Composition | Containing 40% beet | Containing 40% beet | Containing 40% beet | Containing 40% beet |
| | powder (60% olive oil) | powder (60% olive oil) | powder (60% olive oil) | powder (60% olive oil) |
| Average particle diameter | 10 | 10 | 10 | 10 |
| of beet powder (μm) | | | | |
| Beet powder content | 40 | 40 | 40 | 40 |
| (weight percentage, %) | | | | |
| Olive oil content (weight | 60 | 60 | 60 | 60 |
| percentage, %) | | | | |
| Mixing proportion (weight | 48 | 48 | 48 | 48 |
| percentage, %) | | | | |
| Dried foods | Quinoa puff | Quinoa puff | Quinoa puff | Quinoa puff |
| | Raisin | Raisin | Raisin | Raisin |
| | Carrot chips | Carrot chips | Carrot chips | Carrot chips |
| Mixing proportion (weight | 32 | 32 | 32 | 32 |
| percentage, %) | | | | |
| Sugar solution | Concentrated | Concentrated | Concentrated maple | Honey |
| | date juice | sugarcane juice | syrup | |
| Water content (wt %) | 20 | 20 | 20 | 20 |
| Mixing proportion (weight | 20 | 20 | 20 | 20 |
| percentage, %) | | | | |
| Texture of dried foods | 5 | 5 | 5 | 5 |
| Flavor of dried foods | 5 | 5 | 5 | 5 |
| Taste of overall mixture of | 5 | 5 | 5 | 5 |
| foods and oil/fat | | | | |
| Overall evaluation | 5 | 5 | 5 | 5 |
| (including remarks) | | | | |
| Remarks | Possible to mix | Possible to mix | Possible to mix | Possible to mix |
| | uniformly with the | uniformly with the | uniformly with the | uniformly with the |
| | sugar solution; easy to | sugar solution; easy to | sugar solution; easy to | sugar solution; easy to |
| | shape before heat | shape before heat | shape before heat | shape before heat |
| | drying; moderate moist | drying; moderate moist | drying; moderate moist | drying; moderate moist |
| | taste after solidification | taste after solidification | taste after solidification | taste after solidification |

As a result, it was found possible to achieve solidification by using not only concentrated date juice but also the sugar solutions derived from a sugar cane, a maple, and a honey, and a solidified product having the same quality as that of using concentrated date juice can be prepared. In addition, it is clear that the mixtures of these test examples 49 to 52 were substantially free of water due to the composition and heat-drying treatment.

### [Example 9] Preparation of Solidified Mixture of Foods and Oils/Fats

Example 7 revealed the range of optimum water conditions of a sugar solution to be used to solidify a mixture of foods and an oil/fat. Here, an examination was conducted to prepare a product with a higher degree of completion.

According to the formulae described in Table 9, a solidified mixture of foods and an oil/fat was prepared and then evaluated in the same manner as in Examples 1 and 4. Regarding a form for eating, each solidified product was served in the form of bar, so that a person could bite the product while holding with his/her hand(s). Further, dried food particles completely exposed on the surface of the oil/fat composition were not observed, but it was visually confirmed that dried food particles were completely embedded in the oil/fat composition.

Results are shown in Table 9.

TABLE 9

| | | | Test example 53 | |
|---|---|---|---|---|
| | | | | Proportion (weight |
| Raw materials etc. | | | Amount mixed (g) | percentage, %) |
| Oil/fat composition | Plant oil/fat | Rapeseed oil | 110 | 50 |
| (components listed | Plant powder | Green pea powder | 110 | 50 |

| on the right were | Average particle diameter (μm) | 9.8 |
|---|---|---|
| mixed, followed by | Mixing proportion (weight percentage, %) | 22 |
| micronization with | | |
| medium stirring mill | | |
| (bead mill)). | | |
| Dried foods | Quinoa puff | 100 |
| | Dried tomato | 55 |
| | Cashew nut | 80 |
| | Dried date | 170 |
| | Mixing proportion (weight percentage, %) | 41 |
| | Mixing proportion (volume percentage, %) | 59 |
| Others | Green pea powder | 102 |
| | Almond powder | 75 |
| | Black pepper powder | 1.3 |
| | Cumin seed | 0.6 |
| | Cardamon | 0.3 |
| | Common salt | 5.8 |
| Sugar solution | Concentrated apple juice (water content | 190 |
| | 20 wt %) | |
| Total | | 1000 |
| Evaluation results | Flavor of dried foods | 5 |
| | Texture of dried foods | 5 |
| | Taste of overall mixture | 5 |
| | Overall evaluation | 5 |
| | Remarks | The crunch and crispy textures of the dried |
| | | foods matched the moist taste, smooth texture, |
| | | and strong flavor of the oil/fat composition in |
| | | a balanced manner, and the color toner |
| | | (vibrant green) was good. The shape holding |
| | | properly was also good, to exert excellent |
| | | immediate eatability. |

As a result, as the mixtures of foods and oils/fats, and, raw materials other than these materials were combined, the sugar solutions were mixed and then these mixtures were heat-dried for solidification, it was found that the action and the effects of one or more embodiments of the present invention were clearly exhibited. That is, the crunchy and crispy textures of the dried foods matched the moist taste, smooth texture, and strong flavor of the oil/fat composition in a balanced manner, and the color tone was vivid, indicating that the food products enable significantly enjoyable experience of eating. Furthermore, immediate eatability, which is not exhibited by the mixtures of foods and oils/fats, was found to be ensured in addition to their moderate eatability and shape retaining property, demonstrating the action and the effects of one or more embodiments of the present invention. Further, it is clear that the mixture of Test Example 53 was substantially free of water due to the composition and heat-drying treatment.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A food mixture, comprising:
an oil/fat composition that comprises fine plant particles and a plant oil or fat; and
a plant-derived dried food that is embedded in the oil/fat composition,
wherein the fine plant particles have an average particle diameter of 0.3 to 30 μm,
wherein the plant oil/fat is a fluid at 20° C., and
wherein the oil/fat composition contains the fine plant particles in an amount of 10 to 80 mass %.

2. The mixture according to claim 1, wherein the mixture contains the plant-derived dried food in an amount of 20 to 80 mass %.

3. The mixture according to claim 1, wherein the mixture contains the plant-derived dried food in an amount of 25 to 65 vol %.

4. The mixture according to claim 1, wherein the oil/fat composition is prepared by the wet micronization of a dry plant powder with the plant oil or fat.

5. The mixture according to claim 4, wherein the wet micronization is performed using a wet medium stirring mill.

6. The mixture according to claim 1, wherein the fine plant particles are derived from one or more selected from the group consisting of a grain, a potato, a bean, a seed, a vegetable, a mushroom, a spice, and an herb.

7. The mixture according to claim 1, wherein the plant-derived dried food is derived from one or more selected from the group consisting of a grain, a potato, a bean, a seed, a vegetable, a fruit, a mushroom, a spice, and an herb.

8. The mixture according to claim 1, wherein the mixture contains an emulsifier in an amount of 1 mass % or less.

9. The mixture according to claim 1, wherein mixture has a water content of 3 mass % or less.

10. The mixture according to claim 1, wherein the mixture is not heat-sterilized.

11. A solidified mixture that is prepared by solidifying the mixture according to claim 1 with a sugar solution having a water content of 10 to 40 mass %.

12. The solidified mixture according to claim 11, wherein the sugar solution is one or more selected from the group consisting of a plant-derived juice, a sap, a purified product of a plant-derived juice or sap, and a concentrated product of a plant-derived juice or sap.

13. The solidified mixture according to claim 12, wherein the plant-derived juice or sap, a purified product of a plant-derived juice or sap and/or a concentrated product of a plant-derived juice or sap is derived from one or more materials selected from the group consisting of a fruit juice, a date, a sugarcane, a maple, and a honey.

14. A method for producing the mixture according to claim 1, the method comprising mixing the dried food with the oil/fat composition to embed the dried food in the oil/fat composition.

15. The method according to claim 14, further comprising preparing the oil/fat composition through micronization of the fine plant particles and the plant oil/fat using a wet medium stirring mill.

16. A method for producing the solidified mixture according to claim 11, comprising solidifying the mixture by adding the sugar solution to the mixture.

17. The method according to claim 16, wherein the solidification is performed by heat-drying.

18. A method for retaining the texture and the flavor of a plant-derived dried food, comprising:
mixing the dried food with an oil/fat composition to embed the dried food in the oil/fat composition,
wherein the oil/fat composition comprises:
fine plant particles with an average particle diameter of 0.3-30 μm ; and
a plant oil or fat having fluidity at 20° C., and
wherein the oil/fat composition contains the fine plant particles in an amount of 10 to 80 mass %.

19. The method according to claim 18, further comprising preparing the oil/fat composition through micronization of the fine plant particles and the plant oil or fat using a wet medium stirring mill.

20. A method for improving eatability while retaining the texture and the flavor of a plant-derived dried food, the method comprising:
adding a sugar solution with a water content of 10 to 40 mass % to a mixture for solidifying the mixture,
wherein the mixture is prepared by mixing a dried food with an oil/fat composition to embed the dried food in the oil/fat composition,
wherein the oil/fat composition comprises:
fine plant particles having an average particle diameter of 0.3 to 30 μm, and
a plant oil or fat that is a fluid at 20° C., and
wherein the oil/fat composition contains the fine plant particles in an amount of 10 to 80 mass %.

21. The method according to claim 20, further comprising preparing the oil/fat composition through micronization of the fine plant particles and the plant oil or fat using a wet medium stirring mill.

22. The method according to claim 20, wherein the solidification is performed by heat-drying.
